(19) United States
(12) Patent Application Publication
(10) Pub. No.: US 2026/0189609 A1
(43) Pub. Date: Jul. 2, 2026

(54) AUTOMATIC NETWORK SELECTION BASED ON SECURITY CRITERIA

(71) Applicant: Lenovo (Beijing) Limited, Beijing (CN)

(72) Inventors: Ranjeet Gupta, Aurora, IL (US); Daniel C. Chisu, Franklin Park, IL (US); Binsheng Que, Xiamen (CN)

(73) Assignee: Lenovo (Beijing) Limited, Beijing (CN)

(21) Appl. No.: 19/371,781

(22) Filed: Oct. 28, 2025

Related U.S. Application Data
(63) Continuation of application No. PCT/CN2024/144266, filed on Dec. 31, 2024.

(51) Int. Cl. H04L 9/40; H04W 12/00; H04W 12/37

(52) U.S. Cl. CPC H04L 63/20; H04W 12/009; H04W 12/37

(57) ABSTRACT

Automatic network selection based on security criteria is discussed herein. Security criteria for an application (or a website or data) is determined. One or more wireless networks accessible to the computing device are identified and a first wireless network of the one or more wireless networks having a security level that satisfies the security criteria is automatically selected. Data is communicated to or from a first device via the selected wireless network.

### RELATED APPLICATION

This application claims priority benefit of Application Number PCT/CN 2024/144266 filed 31 Dec. 2024 entitled “Automatic Network Selection based on Security Criteria,” the disclosure of which is incorporated by reference herein in its entirety.

### BACKGROUND

As technology has advanced our uses for computing devices have expanded. One such use is wireless communication. Some computing devices, such as cell phones and smart watches, are mobile devices and can communicate with other devices wirelessly. However, such wireless communication is not without its problems. One such problem is security. Malicious users or devices can sometimes intercept or eavesdrop on wireless communications, which can result in private information being revealed so such malicious users or devices. Various security technologies, such as encryption, can be used to protect against such interception or eavesdropping on wireless communications.

### BRIEF DESCRIPTION OF THE DRAWINGS

Embodiments of automatic network selection based on security criteria are described with reference to the following drawings. The same numbers are used throughout the drawings to reference like features and components:

FIG. 1 illustrates an example system including a computing device implementing the techniques discussed herein;

FIG. 2 illustrates an example system implementing the techniques discussed herein;

FIGS. 3 and 4 illustrate examples of implementing the techniques discussed herein;

FIGS. 5-9 illustrate example processes for implementing the techniques discussed herein in accordance with one or more embodiments; and

FIG. 10 illustrates various components of an example electronic device that can implement embodiments of the techniques discussed herein.

### DETAILED DESCRIPTION

Automatic network selection based on security criteria is discussed herein. Generally, a computing device, such as a wireless phone or smartwatch, is able to connect to different wireless networks at different times and different geographical locations, such as different wireless local area networks (WLANs) and different wireless wide area networks (WWANs). Different wireless networks can have different levels of security. For example, some wireless networks encrypt communications between devices and other wireless networks do not encrypt communications between devices, different wireless networks can have different strengths or levels of encryption (e.g., use different encryption key lengths), and so forth.

Different applications running on the computing device can have different security criteria. For example, security criteria for a banking application may indicate a higher level of security than security criteria for a gaming application. An application (e.g., a web browser) running on the computing device can also have different security criteria at different times, e.g., depending on which website the application is accessing. When a particular application is running on the computing device (e.g., launched or is the foreground application), the computing device automatically selects a wireless network that satisfies the security criteria for the application. If the computing device is connected to a wireless network (also referred to as an original wireless network or an initial wireless network) that does not satisfy the security criteria for the application, the computing device automatically connects to the selected wireless network, performs the communication for the application (e.g., transferring data to or receiving data from a remote device), and then reconnects with the original wireless network (e.g., when the application is no longer the foreground application).

Additionally, or alternatively, different data used by the computing device can have different security criteria. For example, security criteria for personal information of a user (e.g., stored in a personal knowledge base) may indicate a higher level of security than security criteria for other data (e.g., the current outdoor temperature). When particular data is being transferred from the computing device to another device, or received by the computing device from another device, the computing device automatically selects a wireless network that satisfies the security criteria for the data. If the computing device is connected to a wireless network (also referred to as an original wireless network or an initial wireless network) that does not satisfy the security criteria for the application, the computing device automatically connects to the selected wireless network, performs the data transfer, and then reconnects with the original wireless network (e.g., after the data transfer is completed).

In contrast to traditional techniques that determine which wireless network to connect to based on the signal strengths of the various wireless networks, the techniques discussed herein determine which wireless network to connect to based at least in part on the security criteria for the application and/or data. This allows the security needs or expectations of the application and/or data to be met while the application is running or data is being communicated, then allows the computing device to reconnect to a different wireless network (e.g., the wireless network having the strongest signal).

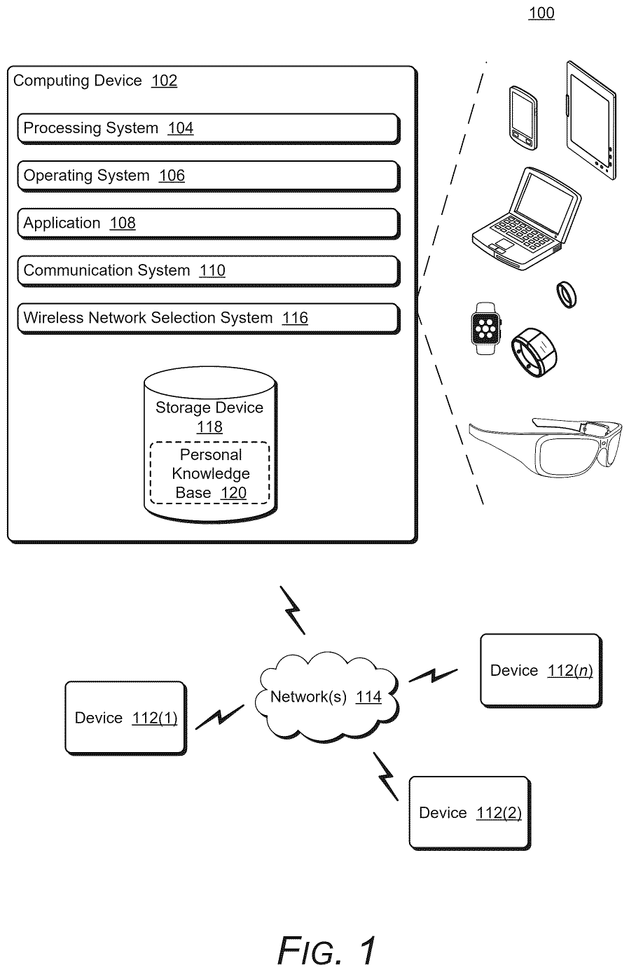

FIG. 1 illustrates an example system 100 including a computing device 102 implementing the techniques discussed herein. The computing device 102 can be, or include, many different types of computing or electronic devices. For example, the computing device 102 can be a smartphone or other wireless phone, a notebook computer (e.g., netbook or ultrabook), a laptop computer, a camera (e.g., compact or single-lens reflex), a wearable device (e.g., a smartwatch, a ring or other jewelry, augmented reality headsets or glasses, virtual reality headsets or glasses), a tablet or phablet computer, a personal media player, a personal navigating device (e.g., global positioning system), an entertainment device (e.g., a gaming console, a portable gaming device, a streaming media player, a digital video recorder, a music or other audio playback device), a video camera, an Internet of Things (IoT) device, a fitness tracker, a smart TV, an automotive computer, and so forth.

The computing device 102 also includes a processing system 104 that includes one or more processors, each of which can include one or more cores. The processing system 104 is coupled with, and may implement functionalities of, any other components or modules of the computing device 102 that are described herein. In one or more embodiments, the processing system 104 includes a single processor having a single core. Additionally, or alternatively, the processing system 104 includes a single processor having multiple cores or multiple processors (each having one or more cores).

The computing device 102 also includes an operating system 106. The operating system 106 manages hardware, software, and firmware resources in the computing device 102. The operating system 106 manages one or more applications 108 running on the computing device 102 and operates as an interface between applications 108 and hardware components of the computing device 102.

An application 108 can be run on the computing device 102 as a foreground application or a background application. A foreground application refers to an application that is visible to and/or providing audio output to the user (e.g., an application that has the user's attention). A foreground application is typically the application that is displayed by the computing device 102. A background application refers to an application that is not visible to and/or providing audio output to the user (e.g., an application that the user is not focusing on, and that the user is not actively using).

The computing device 102 also includes a communication system 110. The communication system 110 manages communication with various other devices 112(1), . . . , 112(n) via one or more networks 114. The devices 112(1), . . . , 112(n) can be, for example, servers associated with various websites (e.g., servers that host websites) or web-based services, computing devices analogous to the computing device 102, and the like. The one or more networks 114 can include wireless networks and/or wired networks. The one or more networks 114 can include wireless networks such as at least one WLAN and/or at least one WWAN. The computing device 102 can thus communicate with other devices wirelessly and accordingly is also referred to as a wireless device.

Different networks can have different security levels that indicate a type of security (e.g., a strength or type of security, or how well the network protects data from being intercepted or understood by eavesdroppers or malicious entities), as discussed in more detail below. For example, a WWAN can support wireless communications across various radio access technologies (RATs) including third generation (3G) radio access technology, fourth generation (4G) radio access technology, fifth generation (5G) radio access technology, 5G advanced (5G A), or other suitable radio access technologies beyond 5G (e.g., sixth generation (6G)). Each of these different radio access technologies can have different levels of security. By way of another example, a WLAN can support different levels of security, such as no security (e.g., an open network), wired equivalent privacy (WEP), Wi-Fi protected access (WPA), Wi-Fi protected access 2 (WPA2), Wi-Fi protected access 3 (WPA3), Wi-Fi protected access 4 (WPA4), WLAN enterprise, and so forth.

The computing device 102 also includes a wireless network selection system 116. The wireless network selection system 116 can be implemented in a variety of different manners. For example, the wireless network selection system 116 can be implemented as multiple instructions stored on computer-readable storage media and that can be executed by the processing system 104. Additionally, or alternatively, the wireless network selection system 116 can be implemented at least in part in hardware (e.g., as an application-specific integrated circuit (ASIC), a field-programmable gate array (FPGA), an application-specific standard product (ASSP), a system-on-a-chip (SoC), a complex programmable logic device (CPLD), and so forth).

The computing device 102 can connect to one or more wireless networks to communicate with one or more of the devices 112(1), . . . , 112(n). Connecting to a wireless network refers to establishing a communication link between the computing device 102 and a network entity (e.g., a base station for a WWAN wireless network, a wireless access point or router for a WLAN wireless network). Connecting to the wireless network can also include registering with the wireless network. This communication link is established without the use of physical cables or wires, and is referred to as wireless. Disconnecting from a wireless network refers to ending the communication link between the computing device 102 and the network entity.

The computing device 102 also includes a storage device 118. The storage device 118 can be implemented using any of a variety of storage technologies, such as magnetic disk, optical disc, Flash or other solid state memory, and so forth. The storage device 118 can store various program instructions and data for any one or more of the operating system 106, application 108, and the wireless network selection system 116.

In one or more implementations, the storage device 118 includes a personal knowledge base 120. The personal knowledge base 120 is an electronic container (e.g., file) used to collect, organize, retrieve, and share personal knowledge. Unlike traditional databases, personal knowledge bases focus on subjective material that is specific to the owner, reflecting their unique interests, insights, and/or expertise. The personal knowledge base 120 is dynamic and can include notes, documents, ideas, and other forms of intellectual content. The personal knowledge base 120 is designed to help users manage their personal information efficiently and can be used for various purposes, such as self-reflection, personal growth, and professional development.

For example, the personal knowledge base 120 can store data input by the user, data obtained from applications 108 (e.g., calendaring applications, airline or travel applications, email applications), data identified by the computing device 102 (e.g., a physical or geographic location of the electronic device), actions taken with or by the computing device 102 at particular times of the day, location information, movement information, previously performed tasks, aspects of tasks previously performed, accepted, or requested by a user of the electronic device, or a combination thereof.

The personal knowledge base 120 can be integrated with artificial intelligence (AI) models to enhance their functionality. For example, the personal knowledge base 120 can store data that AI models use for training and personalization. E.g., an AI model could use information from the personal knowledge base 120 to tailor responses or recommendations to the user's preferences and past interactions. By way of another example, AI models can interact with the personal knowledge base 120 to retrieve and update information based on user queries or commands. This allows for a more personalized and dynamic user experience. By way of another example, AI models can learn from the data stored in the personal knowledge base 120 to improve their accuracy and relevance over time. By analyzing the personal knowledge base 120, the AI models can identify patterns and preferences, leading to better predictions and suggestions. By way of another example, AI models can use the information in the personal knowledge base 120 to generate content that is relevant and personalized to the user. E.g., this could include writing reports, creating summaries, or generating creative content based on the user's interests and expertise.

Accordingly, the personal knowledge base 120 provides a rich source of personalized data that AI models can leverage to deliver more accurate, relevant, and customized services to users.

In one or more implementations, the personal knowledge base 120 is stored locally at the computing device 102 to provide quick, offline access to the personal knowledge base 120. Additionally, or alternatively, the personal knowledge base 120 is stored remotely at one of the devices 112(1), . . . , 112(n), providing access to the personal knowledge base 120 from various devices. In various scenarios, for storage or usage of the personal knowledge base 120, the personal knowledge base 120 is transmitted from the computing device 102 to one of the devices 112(1), . . . , 112(n), and/or is received by the computing device from one of the devices 112(1), . . . , 112(n).

It should be noted that although the personal knowledge base 120 is illustrated in FIG. 1, one or more implementations the computing device 102 may not include the personal knowledge base 120.

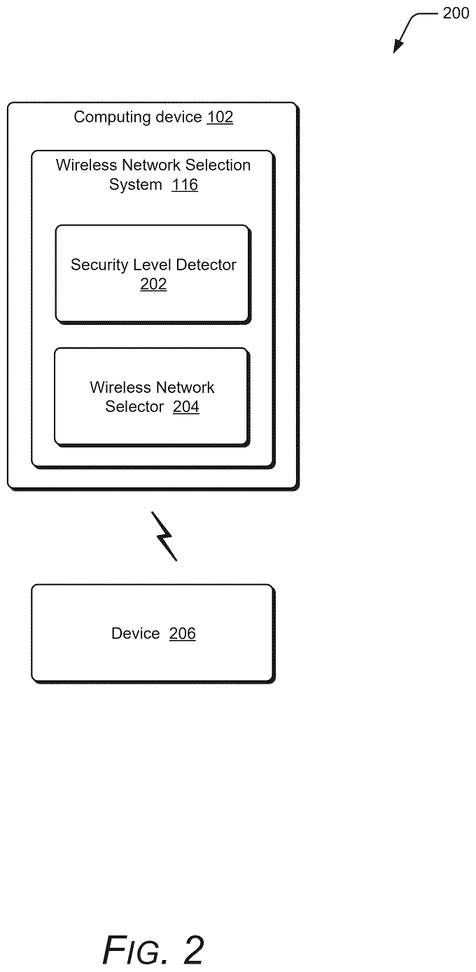

FIG. 2 illustrates an example system 200 implementing the techniques discussed herein. The system 200 includes the computing device 102 with the wireless network selection system 116 of FIG. 1. The wireless network selection system 116 can include a security level detector 202 and a wireless network selector 204. The wireless network selection system 116 communicates with a device 206 via one or more wireless networks as discussed above. The device 206 can be a device 112 of FIG. 1.

The security level detector 202 detects or determines the security level of wireless networks that are available to the computing device 102. A wireless network is available to the computing device 102 when the computing device 102 can receive the wireless network signals (e.g., from a base station, a repeater, a wireless access point, a router, and so forth). In an example, a wireless network is available to the computing device 102 when the wireless network signals received from the wireless network have at least a threshold signal strength. Available wireless networks can be detected or determined, for example, by performing a WWAN network scan to detect or determine available RATs, by performing a WLAN network scan to detect or determine available access points, or a combination thereof.

Different wireless networks can have different security levels. Generally, higher security levels provide more protection or security against malicious users or devices being able to intercept data or information sent by the computing device 102 or received by the computing device 102. These different security levels can be a result of different strengths or levels of encryption used (e.g., using different encryption key lengths), a level of international mobile subscriber identity (IMSI) and password encryption strength (e.g., a length of encryption key(s) used), using different encryption algorithms, implementing encryption at different layers of the wireless communication protocol stack, encrypting different types of identifiers or control information, performing different types of authentication, and so forth.

For WWAN wireless networks, newer generations can have better or higher security levels than older generations. For example, a 5G wireless network has a higher security level than a 4G wireless network.

For WLAN wireless networks, newer generations can have better or higher security levels than older generations. For example, a WPA4 wireless network can have a higher security level than a WPA3 wireless network, a WPA3 wireless network can have a higher security level than a WPA2 wireless network, and so forth.

Some wireless networks can be open wireless networks, which allow any device within range to connect to the wireless network without providing a password. Other wireless networks can be secure networks that require a password to connect to the network. Secure wireless networks can have a higher security level than open wireless networks. Open wireless networks that use encryption (e.g., opportunistic wireless encryption (OWE) as supported by WPA3) can have a higher security level than open wireless networks that do not use encryption. Open wireless networks that use encryption (e.g., OWE) can have a higher security level than some secure wireless networks (e.g., a higher security level than a WEP secure network but a lower security level than a WPA3 secure network).

In one or more implementations, a WWAN network has a higher security level than a WLAN network. Additionally, or alternatively, a WWAN network may or may not have a higher security level than a WLAN network. For example, a WPA4 WLAN wireless network can have a higher security level than a 3G WWAN wireless network, but a lower security level than a 5G WWAN wireless network.

In one or more implementations, wireless networks can be grouped into three groups. A first group has a lowest security level, and may include WEP wireless networks, WPA wireless networks, open wireless networks that do not include encryption, and 2G networks. A second group has a security level higher than the first group, and may include WPA2 wireless networks, WPA3 wireless networks, 3G wireless networks, and 4G wireless networks. A third group has a highest security level, higher than both the first group and the second group, and may include WPA4 wireless networks, 5G wireless networks, newer generation wireless networks than 5G (e.g., 5G A wireless networks, 6G wireless networks), and WLAN enterprise wireless networks.

In one or more implementations, the security levels for wireless networks, and/or which wireless networks have a higher security level than which other wireless networks, are configured in the computing device in various manners, such as pre-configured in the wireless network selection system 116 during manufacture of the computing device 102, received as user input at the computing device 102, provided to the computing device 102 from another device (e.g., a base station in a WWAN network), and so forth.

The wireless network selector 204 selects a wireless network that is available to the computing device 102 based at least in part on the security levels of the available wireless networks and security criteria of the application transmitting data to and/or receiving data from another device via the network. Different applications can have different security criteria. The security criteria for an application is an indication of how secure the application wants or expects the wireless network to be in order to transmit and/or receive data over the wireless network. For example, the security criteria can be a particular security level that the application wants the wireless network to have. By way of another example, the security criteria can be an indication that the application is sensitive (e.g., a wireless network having at least a particular security level is to be used) or not sensitive (e.g., any wireless network can be used regardless of the security level of the wireless network). In one or more implementations, each application has security criteria. Additionally, or alternatively, one or more applications may not have security criteria (e.g., lack of security criteria can be an indication that does not expect the wireless network to be secure in order to transmit data and/or receive data over the wireless network).

In one or more implementations, the security criteria for an application can change based on what actions the application is performing, such as which website the application (e.g., a web browser) is accessing. Different websites can have different security criteria and the application can take on the security criteria of the website being accessed by the application. In one or more implementations, if multiple websites are being accessed concurrently (e.g., different web browser tabs are open each accessing a different website), then the security criteria for all the websites is combined and used as the security criteria for the application (e.g., the wireless network is expected to satisfy the security criteria for all of the websites in the different browser tabs). Additionally, or alternatively, if multiple websites are being accessed concurrently, then the security criteria for one of the websites (e.g., the browsing tab that is currently opened or currently being interacted with by the user of the computing device 102) is used as the security criteria for the application.

In one or more implementations, the security criteria for an application can change based on what data (e.g., files) the application is transferring (e.g., receiving and/or transmitting). Different data can have different security criteria and the application can take on the security criteria of the data being transferred by the application.

Security criteria for an application can be identified in any of a variety of different manners. In one or more implementations, the security criteria for an application is specified in metadata associated with the application. Additionally, or alternatively, the security criteria for an application is determined based on a type of application. The type of the application refers to the functionality that the application provides. Types of applications include, for example, finance applications (e.g., banking or investment applications), news applications, gaming or entertainment applications, travel applications (e.g., ride-sharing applications, airline applications), and so forth. The type of the application can be determined in various manners, such as from metadata associated with the application, a description of the functionality that the application provides, a category associated with the application (e.g., indicated by an application store from which the application is downloaded), and so forth.

Security criteria for a website can be identified in any of a variety of different manners. In one or more implementations, the security criteria for a website is specified in metadata associated with the website. Additionally, or alternatively, the security criteria for a website can be determined based on the uniform resource locator (URL) of the website. For example, a record of different URLs and their security criteria can be maintained by or accessed by the computing device 102. By way of another example, a type of the website can be determined based on the URL. The type of the website refers to the functionality that the website provides. Types of websites include, for example, finance websites (e.g., banking or investment websites), news websites, gaming or entertainment websites, travel websites (e.g., ride-sharing websites, airline websites), and so forth. The type of the website can be determined in various manners, such as from metadata associated with the website, a description of the functionality that the website provides, and so forth.

Additionally, or alternatively, the security criteria for a website can be determined based on data the website requests. For example, the security criteria for a website can be determined based on whether the website has the user log in to the website (e.g., whether a prompt for a user name and password is displayed by the website).

Security criteria for data can be identified in any of a variety of different manners. In one or more implementations, the security criteria for data is specified in metadata associated with the data. Additionally, or alternatively, the security criteria for data can be determined based on the name of the file storing the data. For example, a record of different file names and their security criteria can be maintained by or accessed by the computing device 102. By way of another example, the security criteria for data can be determined based on the name or type of the application transmitting the data or from which the data is received.

In one or more implementations, the wireless network selector 204 selects the wireless network having the highest security level. Additionally, or alternatively, the wireless network selector 204 can select the wireless network in other manners. For example, the wireless network selector 204 can select the wireless network that both satisfies the security criteria for the application and has the highest signal strength. By way of another example, the wireless network selector 204 can select the wireless network that both satisfies the security criteria for the application and has the highest data transfer speed.

If the computing device 102 is connected to a wireless network (also referred to as an original wireless network) other than the wireless network selected by the wireless network selector 204, the computing device 102 (e.g., the communication system 110 of FIG. 1) connects to the wireless network selected by the wireless network selector 204. The computing device 102 may also disconnect from the original wireless network. Communication between the application and the device 206 is performed over the wireless network selected by the wireless network selector 204. After the communication is completed (e.g., the application is closed or is no longer the foreground application), the computing device (e.g., the communication system 110) disconnects from wireless network selected by the wireless network selector 204 and connects to the original wireless network.

In situations where the computing device 102 is already connected to the wireless network selected by the wireless network selector 204, no change (e.g., connection to or disconnection from) in the wireless network that the computing device 102 is connected to need be made.

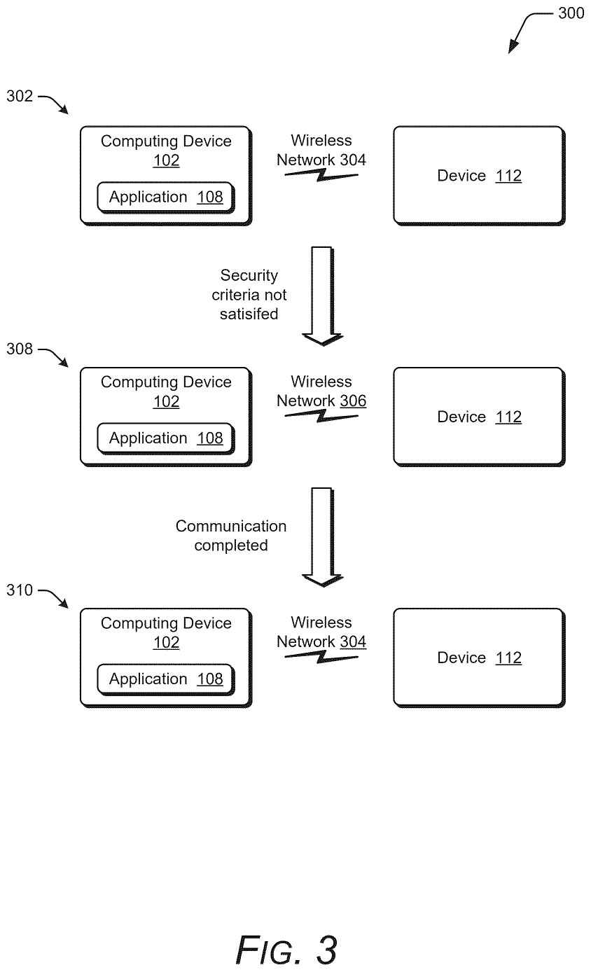

FIG. 3 illustrates an example 300 of implementing the techniques discussed herein. In the example 300, at 302 the computing device 102 is connected to a wireless network 304 and communicates with a device 112 over the wireless network 304. An application 108 running on the computing device 102 is accessed (e.g., launched in response to a user input) and the application 108 has security criteria that is not satisfied by the wireless network 304. Accordingly, the computing device 102 selects and connects to a different wireless network, wireless network 306, having a security level that does satisfy the security criteria of the application 108.

At 308, the application communicates with the device 112 over the wireless network 306. After the communication is completed (e.g., the application 108 is closed or becomes a background application), or the security criteria changes (e.g., due to accessing a different website), the computing device 102 reconnects to the wireless network 304. At 310, the computing device 102, e.g., for applications other than the application 108, can communicate with the device 112 over the wireless network 304.

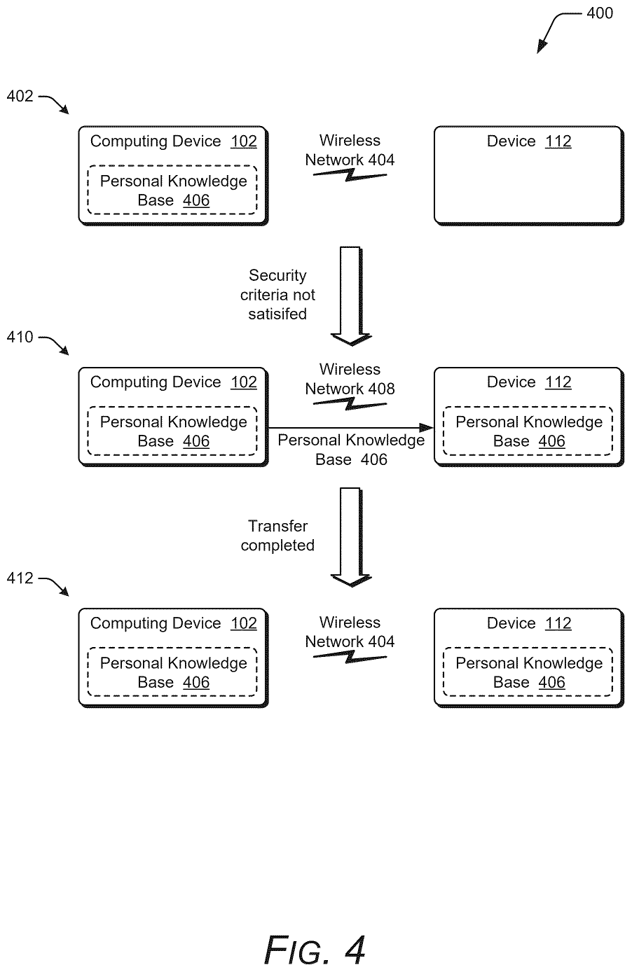

FIG. 4 illustrates an example 400 of implementing the techniques discussed herein. In the example 400, at 402 the computing device 102 is connected to a wireless network 404 and communicates with a device 112 over the wireless network 404. A personal knowledge base 406 on the computing device 102 is to be transferred to the device 112 but the personal knowledge base 406 has security criteria that is not satisfied by the wireless network 404. Accordingly, the computing device 102 selects and connects to a different wireless network, wireless network 408, having a security level that does satisfy the security criteria of the personal knowledge base 406.

At 410, the personal knowledge base 406 is transmitted to the device 112 over the wireless network 408. After the transfer is completed the computing device 102 reconnects to the wireless network 404. At 412 the computing device 102 can communicate with the device 112 over the wireless network 404.

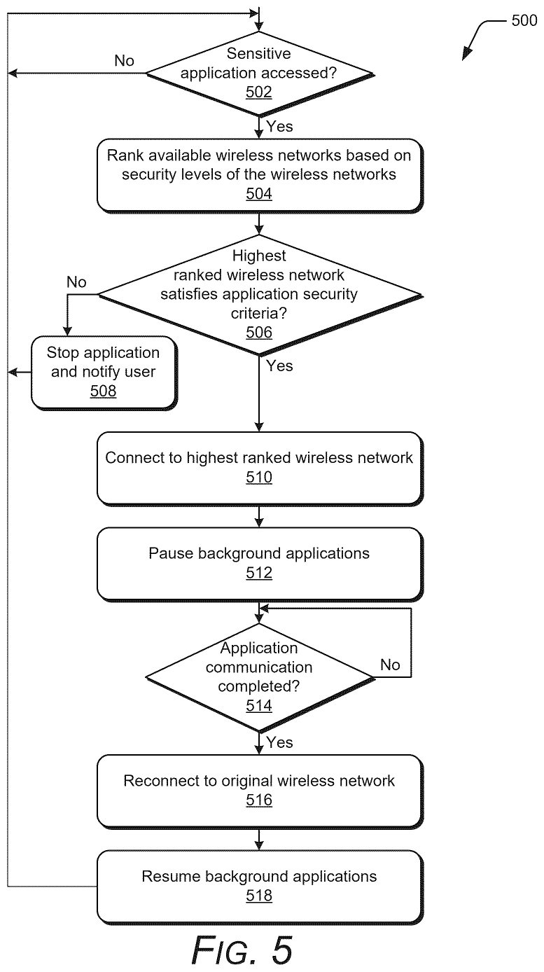

FIG. 5 illustrates an example process 500 for implementing the techniques discussed herein in accordance with one or more embodiments. The example process 500 is performed, for example, by a computing device 102 of FIG. 1 or FIG. 2.

At 502, a determination is made as to whether a sensitive application is accessed. A sensitive application refers to, for example, an application having security criteria indicating that a wireless network having at least a particular security level is to be used when transmitting or receiving data for the application. An application being accessed can be determined in various manners, such as the application being launched (e.g., executed in response to a user input or request to run the application), the application being selected (e.g., by user input) to be the foreground application, and so forth. If a sensitive application is not accessed, the process 500 waits at 502 until a sensitive application is accessed.

At 504, wireless networks available to the computing device are ranked based on their security levels. A wireless network having a higher security level is ranked higher than a wireless network having a lower security level. Correspondingly, a wireless network having a lower security level is ranked lower than a wireless network having a higher security level.

At 506, a check is made as to whether the highest ranked wireless network satisfies security criteria of the application accessed at 502.

At 508, if the highest ranked wireless network does not satisfy the security criteria of the application, the application is stopped (e.g., execution of the application is stopped or is moved to be a background application), and the user is notified. The process 500 then waits at 502 until a sensitive application is accessed. Additionally, or alternatively, a user input can be received indicating that the application is to be allowed to run despite the security criteria not being satisfied.

At 510, if the highest ranked wireless network does satisfy the security criteria of the application (or user input is received indicating that the application is to be allowed to run despite the security criteria not being satisfied), the computing device connects to the highest ranked wireless network. Additionally, or alternatively, the computing device may connect to another wireless network (e.g., having a stronger signal strength than the highest ranked wireless network) that satisfies the security criteria of the application. At 510, the computing device can also disconnect from the wireless network it was previously connected to.

At 512, background applications are paused. This prevents background applications from communicating via the wireless network connected to at 510, allowing the bandwidth of the wireless network connected to at 510 to be reserved for the sensitive application. For example, the data usage of the highest ranked wireless network may be limited or more expensive, so the pausing of background applications can prevent usage of the highest ranked wireless network.

At 514, a check is made whether communication by the application has been completed. Communication by the application can be determined to be over in various manners, such as in response to the application becoming a background application, in response to the application being shut down or closed, and so forth. If communication by the application is not completed, the process 500 waits at 514 until communication by the application is completed.

At 516, the computing device reconnects to the original wireless network. The original wireless network refers to the wireless network that the computing device was connected to prior to connecting to the highest ranked wireless network. At 516, the computing device can also disconnect from the highest ranked wireless network.

At 518, background applications are resumed. This allows the background applications to resume communicating via the original wireless network. The process 500 then waits at 502 until a sensitive application is again accessed.

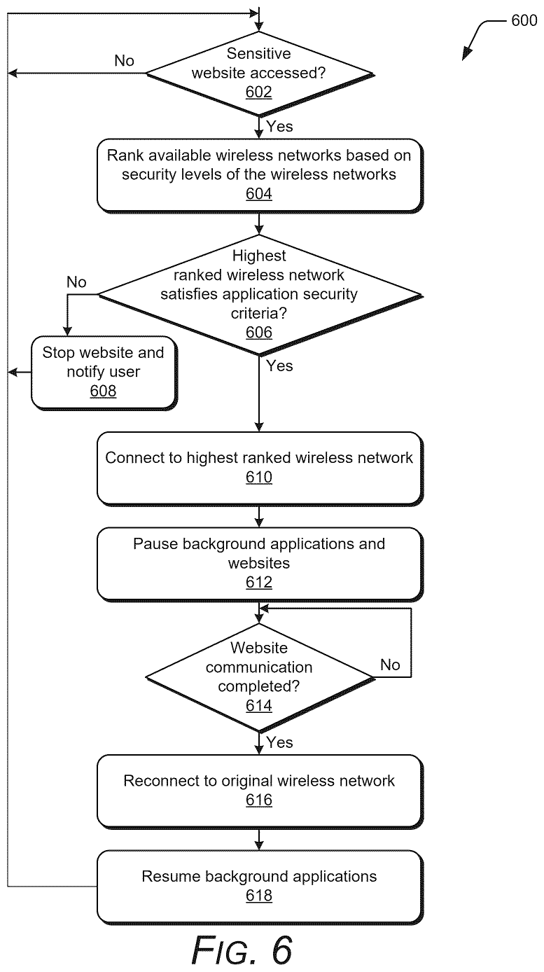

FIG. 6 illustrates an example process 600 for implementing the techniques discussed herein in accordance with one or more embodiments. The example process 600 is performed, for example, by a computing device 102 of FIG. 1 or FIG. 2.

At 602, a determination is made as to whether a sensitive website is accessed. A sensitive website refers to, for example, a website having security criteria indicating that a wireless network having at least a particular security level is to be used when transmitting or receiving data for the website. A website being accessed can be determined in various manners, such as an URL for the website being entered into a web browser, a web browser with a default or specified URL being launched (e.g., executed in response to a user input or request to run the web browser), the website being selected (e.g., by user input) to be the currently opened or currently active website, and so forth. If a sensitive website is not accessed, the process 600 waits at 602 until a sensitive website is accessed.

At 604, wireless networks available to the computing device are ranked based on their security levels. A wireless network having a higher security level is ranked higher than a wireless network having a lower security level. Correspondingly, a wireless network having a lower security level is ranked lower than a wireless network having a higher security level.

At 606, a check is made as to whether the highest ranked wireless network satisfies security criteria of the website accessed at 602.

At 608, if the highest ranked wireless network does not satisfy the security criteria of the website, the website is stopped (e.g., the connection to the website is stopped, the web browser tab accessing the website is closed, or the web browser tab accessing the website is changed to no longer be the currently active or open web browser tab), and the user is notified. The process 600 then waits at 602 until a sensitive website is accessed. Additionally, or alternatively, a user input can be received indicating that the website is to be allowed to run despite the security criteria not being satisfied.

At 610, if the highest ranked wireless network does satisfy the security criteria of the website (or user input is received indicating that the website is to be allowed to run despite the security criteria not being satisfied), the computing device connects to the highest ranked wireless network. Additionally, or alternatively, the computing device may connect to another wireless network (e.g., having a stronger signal strength than the highest ranked wireless network) that satisfies the security criteria of the website. At 610, the computing device can also disconnect from the wireless network it was previously connected to.

At 612, background applications and background websites are paused. A background website refers to a website in a web browser tab that is not the currently active or open web browser tab. This prevents background applications and background websites from communicating via the wireless network connected to at 610, allowing the bandwidth of the wireless network connected to at 610 to be reserved for the sensitive website. For example, the data usage of the highest ranked wireless network may be limited or more expensive, so the pausing of background applications and background websites can prevent usage of the highest ranked wireless network.

At 614, a check is made whether communication by the website has been completed. Communication by the website can be determined to be over in various manners, such as in response to the website becoming a background website, in response to the web browser tab that accessed the website being shut down or closed, in response to the web browser that accessed the website being shut down or closed, and so forth. If communication by the website is not completed, the process 600 waits at 614 until communication by the website is completed.

At 616, the computing device reconnects to the original wireless network. The original wireless network refers to the wireless network that the computing device was connected to prior to connecting to the highest ranked wireless network. At 616, the computing device can also disconnect from the highest ranked wireless network.

At 618, background applications and background websites (if the web browser is still running) are resumed. This allows the background applications and background websites to resume communicating via the original wireless network. The process 600 then waits at 602 until a sensitive website is again accessed.

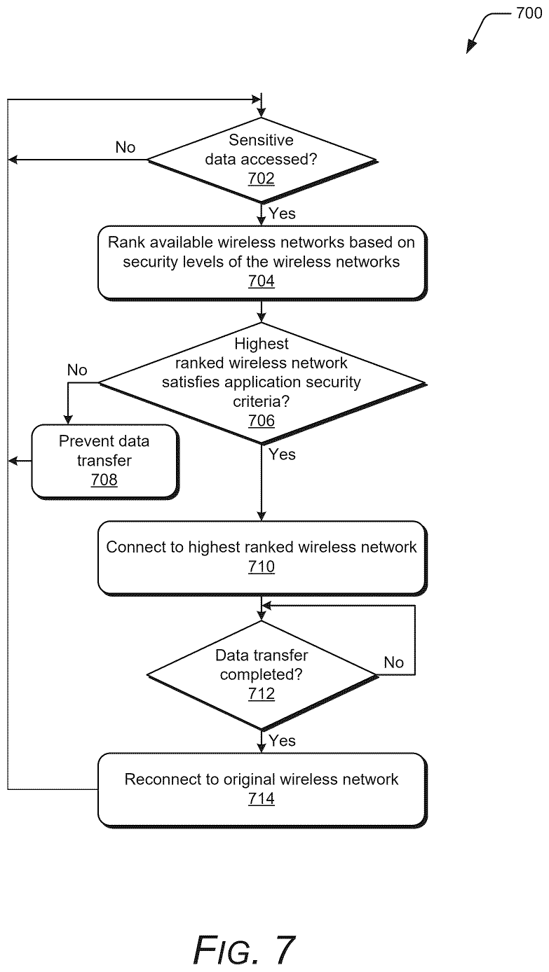

FIG. 7 illustrates an example process 700 for implementing the techniques discussed herein in accordance with one or more embodiments. The example process 700 is performed, for example, by a computing device 102 of FIG. 1 or FIG. 2.

At 702, a determination is made as to whether sensitive data is to be transferred to or from the computing device. Sensitive data refers to, for example, data having security criteria indicating that a wireless network having at least a particular security level is to be used when transmitting or receiving the data. If sensitive data is not accessed, the process 700 waits at 702 until sensitive data is accessed.

At 704, wireless networks available to the computing device are ranked based on their security levels. A wireless network having a higher security level is ranked higher than a wireless network having a lower security level. Correspondingly, a wireless network having a lower security level is ranked lower than a wireless network having a higher security level.

At 706, a check is made as to whether the highest ranked wireless network satisfies security criteria of the website accessed at 702.

At 708, if the highest ranked wireless network does not satisfy the security criteria of the website, the data transfer is prevented. The process 700 then waits at 702 until sensitive data is to be transferred. Additionally, or alternatively, a user input can be received indicating that the data transfer is to be allowed despite the security criteria not being satisfied.

At 710, if the highest ranked wireless network does satisfy the security criteria of the data (or user input is received indicating that the data is to be transferred despite the security criteria not being satisfied), the computing device connects to the highest ranked wireless network. Additionally, or alternatively, the computing device may connect to another wireless network (e.g., having a stronger signal strength than the highest ranked wireless network) that satisfies the security criteria of the data. At 710, the computing device can also disconnect from the wireless network it was previously connected to. Optionally, background applications and background websites are also paused to prevent background applications and background websites from communicating via the wireless network connected to at 710, allowing the bandwidth of the wireless network connected to at 710 to be reserved for the sensitive data.

At 712, a check is made whether the data transfer has been completed. If the data transfer is not completed, the process 700 waits at 712 until the data transfer is completed.

At 714, the computing device reconnects to the original wireless network. The original wireless network refers to the wireless network that the computing device was connected to prior to connecting to the highest ranked wireless network. At 714, the computing device can also disconnect from the highest ranked wireless network. Background applications and background websites that were previously paused (e.g., at 710) are resumed.

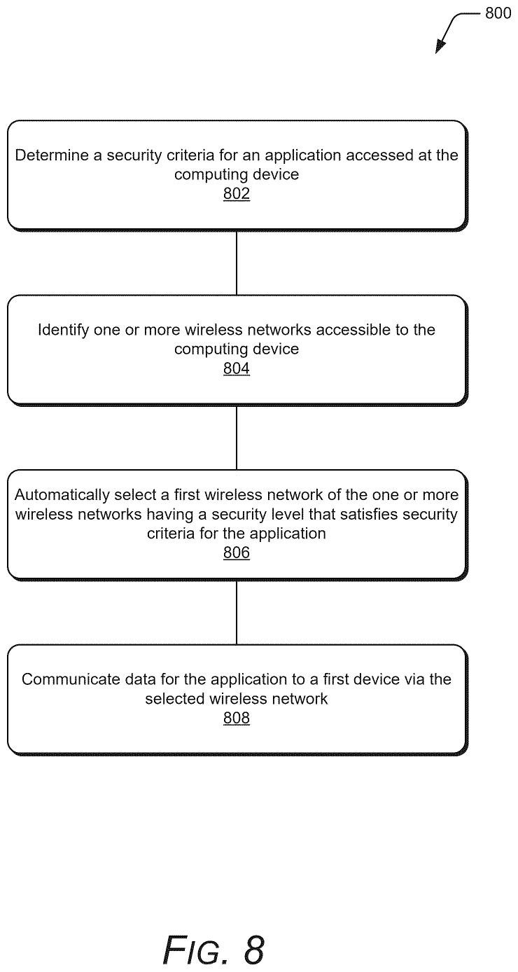

FIG. 8 illustrates an example process 800 for implementing the techniques discussed herein in accordance with one or more embodiments. The process 800 is carried out by a computing device, such as a computing device 102 of FIGS. 1-4, and can be implemented in software, firmware, hardware, or combinations thereof. Process 800 is shown as a set of acts and is not limited to the order shown for performing the operations of the various acts.

At 802, security criteria for an application accessed at the computing device is determined. The security criteria can indicate an expected or required security level for the application to communicate over a wireless network.

At 804, one or more wireless networks accessible to the computing device are identified. These wireless networks can include at least one WLAN and at least one WWAN.

At 806, a first wireless network of the one or more wireless networks having a security level that satisfies security criteria for the application is automatically selected. This can be, for example, one of the one or more wireless networks having a highest security level, or one of the one or more wireless networks that satisfies the security criteria and has the strongest signal.

At 808, data for the application is communicated to a first device via the selected wireless network.

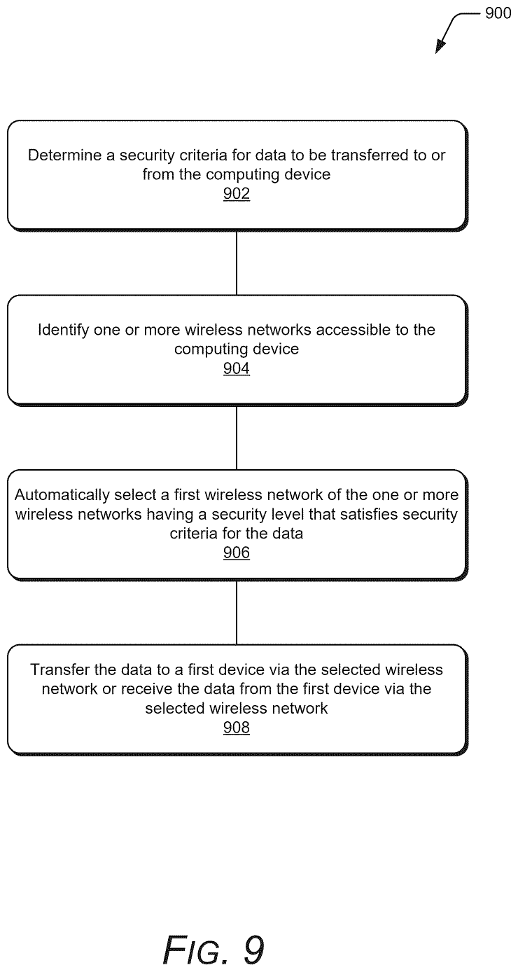

FIG. 9 illustrates an example process 900 for implementing the techniques discussed herein in accordance with one or more embodiments. The process 900 is carried out by a computing device, such as a computing device 102 of FIGS. 1-4, and can be implemented in software, firmware, hardware, or combinations thereof. Process 900 is shown as a set of acts and is not limited to the order shown for performing the operations of the various acts.

At 902, security criteria for data to be transferred to or from the computing device is determined. The data can be, for example, a personal knowledge base. The security criteria can indicate an expected or required security level for the data to communicate over a wireless network.

At 904, one or more wireless networks accessible to the computing device are identified. These wireless networks can include at least one WLAN and at least one WWAN.

At 906, a first wireless network of the one or more wireless networks having a security level that satisfies security criteria for the data is automatically selected. This can be, for example, one of the one or more wireless networks having a highest security level, or one of the one or more wireless networks that satisfies the security criteria and has the strongest signal.

At 908, the data is transferred to a first device via the selected wireless network or received from the first device via the selected wireless network.

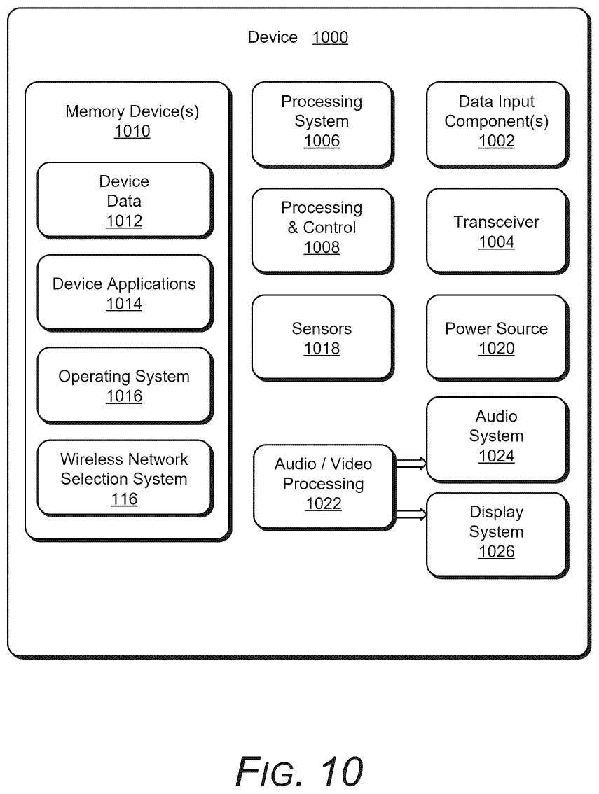

FIG. 10 illustrates various components of an example electronic device that can implement embodiments of the techniques discussed herein. The electronic device 1000 can be implemented as any of the devices described with reference to the previous FIG. s, such as any type of client device, mobile phone, tablet, computing, communication, entertainment, gaming, media playback, or other type of electronic device. In one or more embodiments the electronic device 1000 includes the wireless network selection system 116, described above.

The electronic device 1000 includes one or more data input components 1002 via which any type of data, media content, or inputs can be received such as user-selectable inputs, messages, music, television content, recorded video content, and any other type of text, audio, video, or image data received from any content or data source. The data input components 1002 may include various data input ports such as universal serial bus ports, coaxial cable ports, and other serial or parallel connectors (including internal connectors) for flash memory, DVDs, compact discs, and the like. These data input ports may be used to couple the electronic device to components, peripherals, or accessories such as keyboards, microphones, or cameras. The data input components 1002 may also include various other input components such as microphones, touch sensors, touchscreens, keyboards, and so forth.

The device 1000 includes communication transceivers 1004 that enable one or both of wired and wireless communication of device data with other devices. The device data can include any type of text, audio, video, image data, or combinations thereof. Example transceivers include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, wired local area network (LAN) Ethernet transceivers for network data communication, and cellular networks (e.g., third generation networks, fourth generation networks such as long term evolution (LTE) networks, or fifth generation networks).

The device 1000 includes a processing system 1006 of one or more processors (e.g., any of microprocessors, controllers, and the like) or a processor and memory system implemented as a system-on-chip (SoC) that processes computer-executable instructions. The processing system 1006 may be implemented at least partially in hardware, which can include components of an integrated circuit or on-chip system, an ASIC, aN FPGA, a CPLD, and other implementations in silicon or other hardware.

Additionally, or alternatively, the device can be implemented with any one or combination of software, hardware, firmware, or fixed logic circuitry that is implemented in connection with processing and control circuits, which are generally identified at 1008. The device 1000 may further include any type of a system bus or other data and command transfer system that couples the various components within the device. A system bus can include any one or combination of different bus structures and architectures, as well as control and data lines.

The device 1000 also includes computer-readable storage memory devices 1010 that enable one or both of data and instruction storage thereon, such as data storage devices that can be accessed by a computing device, and that provide persistent storage of data and executable instructions (e.g., software applications, programs, functions, and the like). Examples of the computer-readable storage memory devices 1010 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 1000 may also include a mass storage media device.

The computer-readable storage memory device 1010 provides data storage mechanisms to store the device data 1012, other types of information or data, and various device applications 1014 (e.g., software applications). For example, an operating system 1016 can be maintained as software instructions with a memory device and executed by the processing system 1006 to cause the processing system 1006 to perform various acts. The device applications 1014 may also include a device manager, such as any form of a control application, software application, signal-processing and control module, code that is native to a particular device, a hardware abstraction layer for a particular device, and so on.

The device 1000 can also include one or more device sensors 1018, such as any one or more of an ambient light sensor, a proximity sensor, a touch sensor, an infrared (IR) sensor, accelerometer, gyroscope, thermal sensor, audio sensor (e.g., microphone), and the like. The device 1000 can also include one or more power sources 1020, such as when the device 1000 is implemented as a mobile device. The power sources 1020 may include a charging or power system, and can be implemented as a flexible strip battery, a rechargeable battery, a charged super-capacitor, or any other type of active or passive power source.

The device 1000 additionally includes an audio or video processing system 1022 that generates one or both of audio data for an audio system 1024 and display data for a display system 1026. In accordance with some embodiments, the audio/video processing system 1022 is configured to receive call audio data from the transceiver 1004 and communicate the call audio data to the audio system 1024 for playback at the device 1000. The audio system or the display system may include any devices that process, display, or otherwise render audio, video, display, or image data. Display data and audio signals can be communicated to an audio component or to a display component, respectively, via an RF (radio frequency) link, S-video link, HDMI (high-definition multimedia interface), composite video link, component video link, DVI (digital video interface), analog audio connection, or other similar communication link. In implementations, the audio system or the display system are integrated components of the example device. Additionally, or alternatively, the audio system or the display system are external, peripheral components to the example device.

In the discussions herein, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Although embodiments of techniques for automatic network selection based on security criteria have been described in language specific to features or methods, the subject of the appended claims is not necessarily limited to the specific features or methods described. Rather, the specific features and methods are disclosed as example implementations of techniques for implementing automatic network selection based on security criteria. Further, various different embodiments are described, and it is to be appreciated that each described embodiment can be implemented independently or in connection with one or more other described embodiments. Additional aspects of the techniques, features, and/or methods discussed herein relate to one or more of the following.

In some aspects, the techniques described herein relate to a computing device including: at least one memory; and at least one processor coupled with the at least one memory and configured to cause the computing device to: determine a security criteria for an application accessed at the computing device; identify one or more wireless networks accessible to the computing device; automatically select a first wireless network of the one or more wireless networks having a security level that satisfies security criteria for the application; and communicate data for the application to a first device via the selected wireless network.

In some aspects, the techniques described herein relate to a computing device, wherein the application includes an application running on the computing device.

In some aspects, the techniques described herein relate to a computing device, wherein the security criteria for the application is based at least in part on a website that is accessed by the application and that is hosted by the first device.

In some aspects, the techniques described herein relate to a computing device, wherein the data includes a personal knowledge base of a user of the computing device.

In some aspects, the techniques described herein relate to a computing device, wherein the application includes a web browser and wherein the security criteria for the application is different for different websites accessed by the web browser.

In some aspects, the techniques described herein relate to a computing device, wherein the one or more wireless networks have different security levels.

In some aspects, the techniques described herein relate to a computing device, wherein the first wireless network includes a wireless network having a highest security level of the one or more wireless networks.

In some aspects, the techniques described herein relate to a computing device, wherein the at least one processor is further configured to cause the computing device to: automatically connect to the first wireless network to communicate the data for the application to the device; and automatically connect, based at least in part on communication by the application with the device having been completed, to a second wireless network, wherein the computing device was connected to the second wireless network prior to communication of the data for the application to the device.

In some aspects, the techniques described herein relate to a computing device, wherein the at least one processor is further configured to cause the computing device to: pause one or more background applications on the computing device while the computing device is connected to the first wireless network; and resume the one or more background applications based at least in part on the computing device connected to the second wireless network.

In some aspects, the techniques described herein relate to a computing device, wherein the one or more wireless networks include at least one wireless local area network (WLAN) and at least one wireless wide area network (WWAN).

In some aspects, the techniques described herein relate to a computing device including: at least one memory; and at least one processor coupled with the at least one memory and configured to cause the computing device to: determine a security criteria for data to be transferred to or from the computing device; identify one or more wireless networks accessible to the computing device; automatically select a first wireless network of the one or more wireless networks having a security level that satisfies security criteria for the data; and transfer the data to a first device via the selected wireless network or receive the data from the first device via the selected wireless network.

In some aspects, the techniques described herein relate to a computing device, wherein the data includes a personal knowledge base of a user of the computing device.

In some aspects, the techniques described herein relate to a computing device, wherein the one or more wireless networks have different security levels.

In some aspects, the techniques described herein relate to a computing device, wherein the first wireless network includes a wireless network having a highest security level of the one or more wireless networks.

In some aspects, the techniques described herein relate to a computing device, wherein the at least one processor is further configured to cause the computing device to: automatically connect to the first wireless network to transfer the data to or from the device; and automatically connect, based at least in part on the transfer of the data to or from the device having been completed, to a second wireless network, wherein the computing device was connected to the second wireless network prior to communication of the data to or from the device.

In some aspects, the techniques described herein relate to a method including: determining a security criteria for an application accessed at a computing device; identifying one or more wireless networks accessible to the computing device; automatically selecting a first wireless network of the one or more wireless networks having a security level that satisfies security criteria for the application; and communicating data for the application to a first device via the selected wireless network.

In some aspects, the techniques described herein relate to a method, wherein the first wireless network includes a wireless network having a highest security level of the one or more wireless networks.

In some aspects, the techniques described herein relate to a method, further including: automatically connecting to the first wireless network to communicate the data for the application to the device; and automatically connecting, based at least in part on communication by the application with the device having been completed, to a second wireless network, wherein the computing device was connected to the second wireless network prior to communication of the data for the application to the device.

In some aspects, the techniques described herein relate to a method, further including: pausing one or more background applications on the computing device while the computing device is connected to the first wireless network; and resuming the one or more background applications based at least in part on the computing device connected to the second wireless network.

In some aspects, the techniques described herein relate to a method, wherein the one or more wireless networks include at least one wireless local area network (WLAN) and at least one wireless wide area network (WWAN).

What is claimed is:

1. A computing device comprising:
at least one memory; and
at least one processor coupled with the at least one memory and configured to cause the computing device to:
determine a security criteria for an application accessed at the computing device;
identify one or more wireless networks accessible to the computing device;
automatically select a first wireless network of the one or more wireless networks having a security level that satisfies security criteria for the application; and
communicate data for the application to a first device via the selected wireless network.

2. The computing device of claim 1, wherein the application comprises an application running on the computing device.

3. The computing device of claim 1, wherein the security criteria for the application is based at least in part on a website that is accessed by the application and that is hosted by the first device.

4. The computing device of claim 1, wherein the data comprises a personal knowledge base of a user of the computing device.

5. The computing device of claim 1, wherein the application comprises a web browser and wherein the security criteria for the application is different for different websites accessed by the web browser.

6. The computing device of claim 1, wherein the one or more wireless networks have different security levels.

7. The computing device of claim 1, wherein the first wireless network comprises a wireless network having a highest security level of the one or more wireless networks.

8. The computing device of claim 1, wherein the at least one processor is further configured to cause the computing device to:
automatically connect to the first wireless network to communicate the data for the application to the device; and
automatically connect, based at least in part on communication by the application with the device having been completed, to a second wireless network, wherein the computing device was connected to the second wireless network prior to communication of the data for the application to the device.

9. The computing device of claim 8, wherein the at least one processor is further configured to cause the computing device to:
pause one or more background applications on the computing device while the computing device is connected to the first wireless network; and
resume the one or more background applications based at least in part on the computing device connected to the second wireless network.

10. The computing device of claim 1, wherein the one or more wireless networks include at least one wireless local area network (WLAN) and at least one wireless wide area network (WWAN).

11. A computing device comprising:
at least one memory; and
at least one processor coupled with the at least one memory and configured to cause the computing device to:
determine a security criteria for data to be transferred to or from the computing device;
identify one or more wireless networks accessible to the computing device;
automatically select a first wireless network of the one or more wireless networks having a security level that satisfies security criteria for the data; and
transfer the data to a first device via the selected wireless network or receive the data from the first device via the selected wireless network.

12. The computing device of claim 11, wherein the data comprises a personal knowledge base of a user of the computing device.

13. The computing device of claim 11, wherein the one or more wireless networks have different security levels.

14. The computing device of claim 11, wherein the first wireless network comprises a wireless network having a highest security level of the one or more wireless networks.

15. The computing device of claim 11, wherein the at least one processor is further configured to cause the computing device to:
automatically connect to the first wireless network to transfer the data to or from the device; and
automatically connect, based at least in part on the transfer of the data to or from the device having been completed, to a second wireless network, wherein the computing device was connected to the second wireless network prior to communication of the data to or from the device.

16. A method comprising:
determining a security criteria for an application accessed at a computing device;
identifying one or more wireless networks accessible to the computing device;
automatically selecting a first wireless network of the one or more wireless networks having a security level that satisfies security criteria for the application; and
communicating data for the application to a first device via the selected wireless network.

17. The method of claim 16, wherein the first wireless network comprises a wireless network having a highest security level of the one or more wireless networks.

18. The method of claim 16, further comprising:
automatically connecting to the first wireless network to communicate the data for the application to the device; and
automatically connecting, based at least in part on communication by the application with the device having been completed, to a second wireless network, wherein the computing device was connected to the second wireless network prior to communication of the data for the application to the device.

19. The method of claim 18, further comprising:
pausing one or more background applications on the computing device while the computing device is connected to the first wireless network; and
resuming the one or more background applications based at least in part on the computing device connected to the second wireless network.

20. The method of claim 16, wherein the one or more wireless networks include at least one wireless local area network (WLAN) and at least one wireless wide area network (WWAN).
